(19) United States
(12) Patent Application Publication
(10) Pub. No.: US 2021/0037386 A1
(43) Pub. Date: Feb. 4, 2021

(54) FLEXIBLE VEHICLE SHARING MODULE

(71) Applicant: GM Global Technology Operations LLC, Detroit, MI (US)

(72) Inventors: Christopher L. Oesterling, Troy, MI (US); Paul H. Pebbles, Novi, MI (US)

(21) Appl. No.: 16/529,217

(22) Filed: Aug. 1, 2019

(51) Int. Cl. H04W 12/08; G06F 1/14; G06F 1/3203; G06F 21/60

(52) U.S. Cl. CPC H04W 12/0808; G06F 21/602; G06F 1/3203; G06F 1/14

(57) ABSTRACT

A flexible vehicle sharing module of a vehicle is provided. The flexible vehicle sharing module includes a controller area network interface adapter that identifies the vehicle. The flexible vehicle sharing module also includes a cybersecurity software firewall module and a key fob board. The cybersecurity software firewall module establishes a software firewall that monitors and controls incoming data communications to the flexible vehicle sharing module. The key fob board includes a circuit board for managing input/output signals respective to key fob commands. The flexible vehicle sharing module includes a cryptographic module that performs hashing, signing, and secure storage of messages to the vehicle.

### INTRODUCTION

The subject disclosure relates to a flexible vehicle sharing module.

A vehicle sharing module (VSM) is an aftermarket device installed into vehicles to support car sharing services. A VSM wirelessly communicates with a mobile device of a car sharing user to allow vehicle access actions, such as a door lock, door unlock, horn honk, and/or flash lights, with respect to the car sharing services. For instance, the VSM can perform a physical vehicle door unlock via sending a door unlock command over a vehicle bus to a body control module.

To improve vehicle cyber security, vehicle manufactures are introducing firewall devices and vehicle bus architectures to prevent aftermarket devices (such as a VSM) from writing on the vehicle bus and thus blocking commands. In this regard, utilizing a VSM is problematic for future vehicles. More particularly, no car sharing hardware currently supports all vehicle makes and models.

### SUMMARY

In accordance with one or more embodiments, a flexible vehicle sharing module of a vehicle is provided. The flexible vehicle sharing module includes a controller area network interface adapter that identifies the vehicle. The flexible vehicle sharing module also includes a cybersecurity software firewall module and a key fob board. The cybersecurity software firewall module establishes a software firewall that monitors and controls incoming data communications to the flexible vehicle sharing module. The key fob board includes a circuit board for managing input/output signals respective to key fob commands. The flexible vehicle sharing module includes a cryptographic module that performs hashing, signing, and secure storage of messages to the vehicle.

In accordance with one or more embodiments or the flexible vehicle sharing module embodiment above, the flexible vehicle sharing module can include a remote ignition block module that includes an inline printed circuit board relay with separate input/output lines that prevent the vehicle from restarting once an ignition therein is turned off.

In accordance with one or more embodiments or any of the flexible vehicle sharing module embodiments above, the flexible vehicle sharing module can include a global position system that determines vehicle position.

In accordance with one or more embodiments or any of the flexible vehicle sharing module embodiments above, the flexible vehicle sharing module can include a network access device that conducts long distance data communications with remote entity.

In accordance with one or more embodiments or any of the flexible vehicle sharing module embodiments above, the flexible vehicle sharing module can include a real-time clock that manages a computer clock to keep track of the current time.

In accordance with one or more embodiments or any of the flexible vehicle sharing module embodiments above, the flexible vehicle sharing module can include a power management module including at least a ground and provides a power supply and maintenance to the flexible vehicle sharing module.

In accordance with one or more embodiments or any of the flexible vehicle sharing module embodiments above, the flexible vehicle sharing module can determine whether a controller area network of the vehicle requires encrypted communications.

In accordance with one or more embodiments or any of the flexible vehicle sharing module embodiments above, the flexible vehicle sharing module can determine whether a gateway module is present within the vehicle.

In accordance with one or more embodiments or any of the flexible vehicle sharing module embodiments above, the flexible vehicle sharing module can determine receives communications from a mobile device.

In accordance with one or more embodiments, a system is provided. The system includes a mobile device with a memory and a processor therein. The memory storing program instructions executable by the processor. The system includes a flexible vehicle sharing module of a vehicle. The flexible vehicle sharing module includes a controller area network interface adapter that identifies the vehicle. The flexible vehicle sharing module also includes a cybersecurity software firewall module and a key fob board. The cybersecurity software firewall module establishes a software firewall that monitors and controls incoming data communications to the flexible vehicle sharing module. The key fob board includes a circuit board for managing input/output signals respective to key fob commands. The flexible vehicle sharing module includes a cryptographic module that performs hashing, signing, and secure storage of messages to the vehicle.

In accordance with one or more embodiments or the system embodiment above, the flexible vehicle sharing module can include a remote ignition block module that includes an inline printed circuit board relay with separate input/output lines that prevent the vehicle from restarting once an ignition therein is turned off.

In accordance with one or more embodiments or any of the system embodiments above, the flexible vehicle sharing module can include a global position system that determines vehicle position.

In accordance with one or more embodiments or any of the system embodiments above, the flexible vehicle sharing module can include a network access device that conducts long distance data communications with remote entity.

In accordance with one or more embodiments or any of the system embodiments above, the flexible vehicle sharing module can include a real-time clock that manages a computer clock to keep track of the current time.

In accordance with one or more embodiments or any of the system embodiments above, the flexible vehicle sharing module can include a power management module including at least a ground and provides a power supply and maintenance to the flexible vehicle sharing module.

In accordance with one or more embodiments or any of the system embodiments above, the flexible vehicle sharing module can determine whether a controller area network of the vehicle requires encrypted communications.

In accordance with one or more embodiments or any of the system embodiments above, the flexible vehicle sharing module can determine whether a gateway module is present within the vehicle.

In accordance with one or more embodiments or any of the system embodiments above, the flexible vehicle sharing module can determine receives communications from a mobile device.

In accordance with one or more embodiments or the flexible vehicle sharing module above, the flexible vehicle sharing module can provide operations of a virtual key fob to allow vehicle access actions.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a communication flow diagram between communicating entities for a vehicle sharing system according to one or more embodiments;

FIG. 2 depicts a block diagram of a flexible vehicle sharing module according to one or more embodiments; and

FIG. 3 depicts a process flow of a flexible vehicle sharing module according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with one or more embodiments, a system and method for a flexible vehicle sharing module (FVSM) is provided herein. The FVSM can support both legacy vehicles and newer model year vehicles by combining vehicle bus write capabilities and universal key fob circuit board technology. In this regard, this or a vehicle sharing system expands support for Peer to Peer (P2P) car sharing service business models and solves logistical issues of installing car sharing hardware.

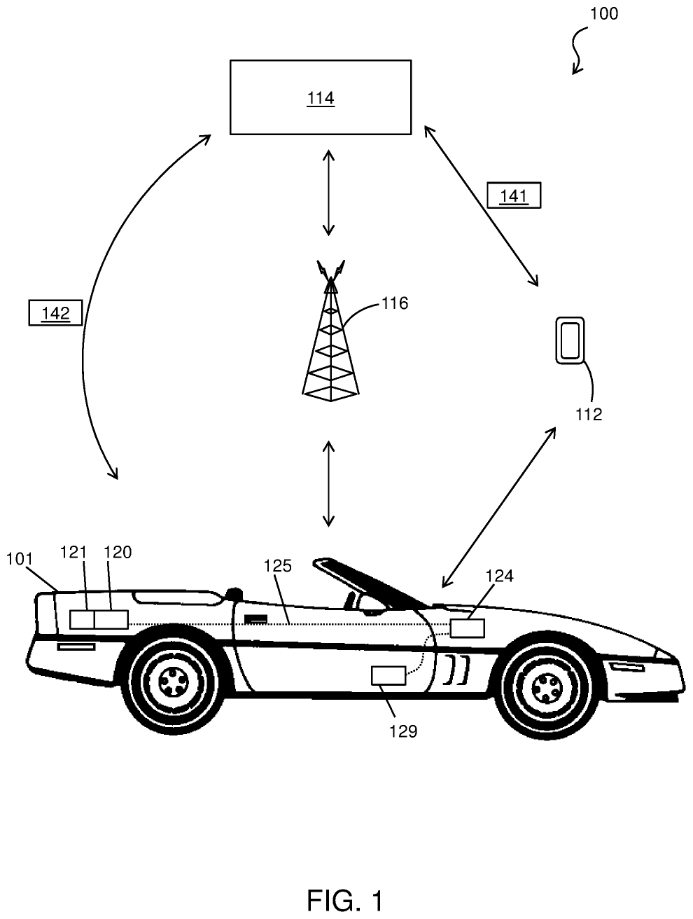

FIG. 1 depicts a communication flow diagram between communicating entities for a vehicle sharing system 100 according to one or more embodiments. The vehicle sharing system 100 includes a vehicle 101 that communicates with a mobile device 112 and/or a remote entity 114, whether indirectly across a wireless carrier system 116 or directly (e.g., the vehicle 101, the mobile device 112, the remote entity 114, and a FVSM 120 have wireless communications capabilities.). The vehicle 101 includes the FVSM 120 (with an antenna system 121, either internal or external to an enclosure/housing of the FVSM 120) that assists in authenticating the mobile device 112 to the vehicle 101 for enabling vehicle operations. The vehicle 101 also includes a body control module (BCM) 124, a controller area network (CAN) 125, and an existing communication port 129. It should be understood that although an automobile is depicted as a vehicle 101, the embodiments described herein can be applied to other types of systems where shared access is utilized including, but are not limited to, rail systems, aircraft, off-road sport vehicles, robotic vehicles, motorcycles, farm equipment, and construction equipment.

The vehicle sharing system 100 allows a user to reserve a respective vehicle parked by a previous user at a respective location utilizing the mobile computing device. The vehicle sharing system 100 implements Short Range Wireless Communication (SRWC) technology to connect the mobile device 112 to the FVSM 120 so that vehicle functions (such as, but not limited to, vehicle access and operation) may be performed by the mobile device 112 without requiring a vehicle key or corresponding key fob to perform vehicle operations.

The mobile device 112 may be embodied as a smart phone, tablet, or some similar device capable of communicating with the vehicle 101 and the remote entity 114 via FVSM 120 (e.g., through short range wireless communications (SRWC), discussed herein). For the illustrative purposes described herein, a smart phone will be used and shown herein, however it should be understood that the embodiments described herein are not limited to a smart phone (for example, they may be a wearable computing device). In accordance with one or more embodiments, the mobile device may include a mobile application (e.g., a ride sharing application) that is capable of connecting to and communicating with the FVSM 120. In this regard, one or more vehicle access actions can be initiated through the mobile application to the FSVM 120.

The remote entity 114 may be a server that incorporates a data controller which controls its operations. The remote entity 114 may also incorporate a memory that includes one or more application program interface (API) suites. One API suite can incorporate numerous vehicle-share services records (i.e., vehicle reservation information) each having information related to vehicle 101 such as, but not limited to, vehicle-share vehicle records, information related to a vehicle share system user such as, but not limited to, reservation account records. The vehicle-share services records can also include information related to organizing vehicle reservations as well as fleet management such as, but not limited to, reservation profile records, or any other pertinent vehicle-share system information. These records could moreover be written in SQL as well as be copied, organized, and/or stored in a tabular form to allow for continuous, real-time updates.

The wireless carrier system 116 can be a cellular telephone system that includes a plurality of cell towers, one or more cellular network infrastructures, as well as any other networking components required to connect the wireless carrier system 116 with corresponding land network for long-distance communications. As is generally known, each cell tower may also include sending and receiving antennas and a base station. The wireless carrier system 116 can implement any suitable communications technology, including, for example, analog or digital technologies such as, but not limited to, 3G, 4G LTE, and 5G.

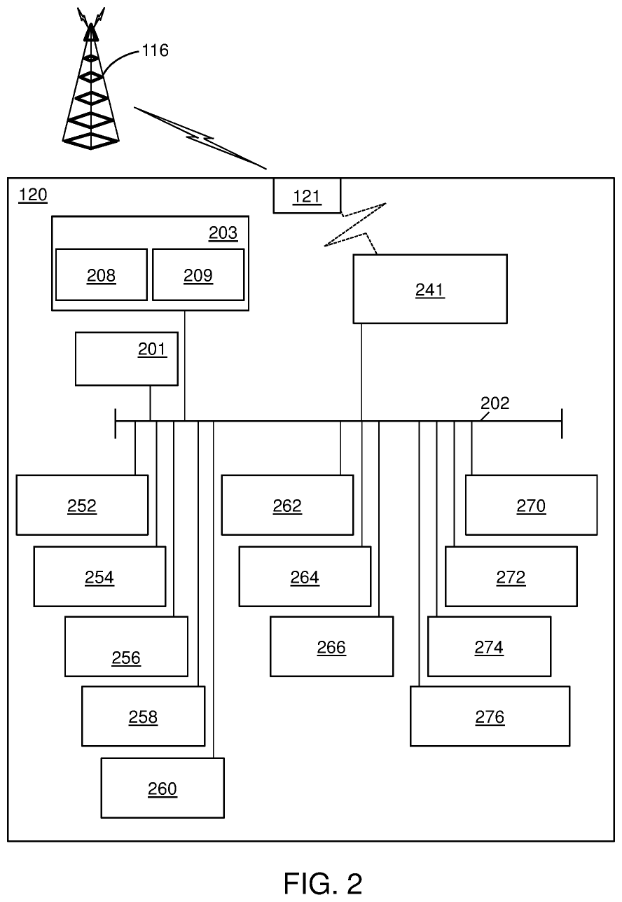

The FVSM 120 may be permanently installed as part of the vehicle's architecture during vehicle manufacture as shown in FIG. 1 or may be an aftermarket device that is plugged into the existing communication port 129 within vehicle 101 (OBD or ALDL). When permanently installed, FVSM 120 may be directly connected to the CAN 125 through a single wire (low speed) vehicle bus or dual wire (high speed) vehicle bus. The FVSM 120 can detect vehicle bus architecture and technology/components therein (e.g., the CAN 125 or a key fob board 266, FIG. 2) to perform vehicle access services.

The antenna system 121 may include multiple antennas to enable the FVSM 120 to communicate with one or more remote computing devices (e.g., the remote entity 114 and the mobile device 112). For example, the antenna system 121 may include a cellular antenna that is equipped to transmit and receive long distance data communications over the wireless carrier system 116. The antenna system 121 may also include an antenna that is equipped to transmit and receive data communications over a short-range wireless communication (SRWC) protocol such as, but not limited to, Bluetooth Low Energy and WIFI. The antenna system 121 may also include an antenna that is equipped to receive GPS satellite signals and generating GPS coordinates based on those signals. It should be understood that each antenna of the antenna system 121 may be in one location of vehicle 101 or they may be located at different vehicle locations. It should be further understood that the antenna system 121 may be installed within the enclosure of FVSM 120.

The BCM 124 that monitors and governs various electrical components located throughout the vehicle body, for example, the vehicle's power door locks, air conditioner, engine ignition, vehicle seat adjustment and heating, mirrors, and headlights. As follows, the BCM 124 includes various vehicle functionality including, but not limited to, door lock and unlock, trunk or tailgate release, sound horn, remote start, and engine start/stop.

The CAN 125 is a vehicle bus standard that allows the FVSM 120 to be indirectly coupled to the BCM 124 and other vehicle system modules. The CAN 125 can be encrypted to prevent unauthorized access to the vehicle 101, such as vehicle access operations. The CAN 125 can include a gateway module, which further prevents unauthorized access to the vehicle 101.

Turning now to FIG. 2, a block diagram of the FVSM 120, according to one or more embodiments is illustrated. The FVSM 120 can be an electronic, computer framework comprising and/or employing any number and combination of computing device and networks utilizing various communication technologies, as described herein. The FVSM 120 can be easily scalable, extensible, and modular, with the ability to change to different services or reconfigure some features independently of others. It should be understood that the FVSM 120 can be constructed with a plurality of printed circuit boards (PCBs) or can be a single PCB. The FVSM 120 may, moreover, be packaged in a tamperproof and potted enclosure that is secured at some location within the vehicle interior. The FVSM 120 may also be packaged with established security mechanisms that protect against unauthorized usage or theft (e.g., by disabling the remote keyless functionality). Generating passive commands can now be performed by the FVSM 120 upon acquiring the proper digitally encrypted authorization keys, as described herein.

The FVSM 120 has a processor 201, which can include one or more central processing units (CPUs). The processor 201, also referred to as a processing circuit, microprocessor, computing unit, is coupled via a system bus 202 to a system memory 203 and various other components. The system memory 203 may include read only memory (ROM) and random access memory (RAM). The ROM is coupled to the system bus 202 and may include a basic input/output system (BIOS), which controls certain basic functions of the FVSM 120. The RAM is read-write memory coupled to the system bus 202 for use by the processor 201.

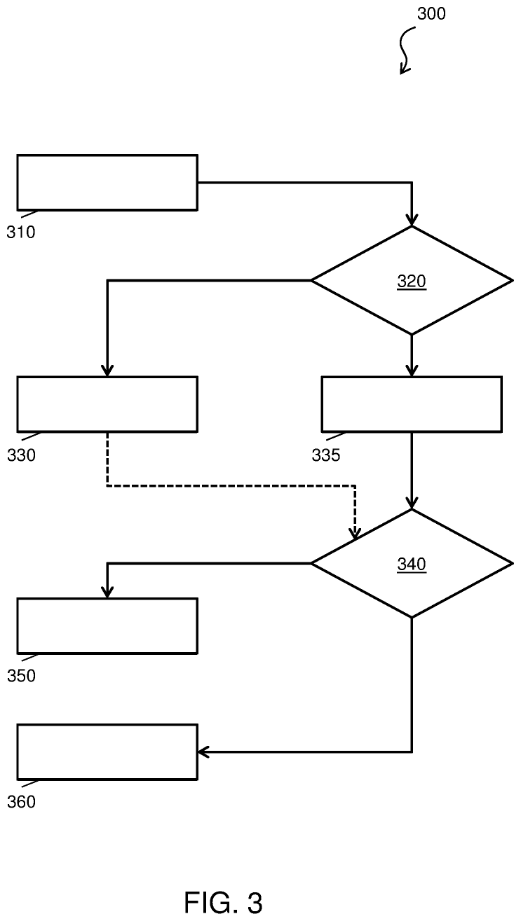

The system memory 203 is an example of a tangible storage medium readable executable by the processor 201. The system memory 203 stores software 208 and data 209. The software 208 is stored as instructions for execution on the FVSM 120 by the processor 201 (to perform process, such as the process flows of FIG. 3). The data 209 includes a set of values of qualitative or quantitative variables organized in various data structures to support and be used by operations of the software 208. The operations of the software 208 and the data 209 (e.g., the FVSM 120) are necessarily rooted in the computational ability of the processor 201 to overcome and address the herein-described shortcomings of the conventional vehicle sharing modules. In this regard, the software 208 and the data 209 improve computational operations of the processor 201 of the FVSM 120.

The FVSM 120 has one or more adapters and/or interfaces that interconnect and support communications between the processor 201, the system memory 203, and other components of the system 100 (e.g., peripheral and external devices). As shown, the FVSM 120 includes a communications adapter 241 that interconnects the system bus 202 with the antenna system 121 enabling the FVSM 120 to communicate with other systems, devices, data, and software, such as the wireless carrier system 116. For example, the communications adapter 241 can include a wireless communications module (otherwise known as “SRWC module”) and is coupled to the antenna system 121.

Further, the FVSM 120 includes a CAN interface adapter 252, a CAN transceiver 254, a cybersecurity software firewall (CSF) module 256, a universal serial bus (USB) 258, and a cryptographic module (CMS) 260. The FVSM 120 also includes a remote ignition block (RIB) module 262, a RIB driver 264, the key fob board 266, and a global position system (GPS) module 270. The FVSM 120 includes a network access device (NAD) 272, a real-time clock (RTC) 274, and a power management module 276. One or more of these components may be hardware based, software based, or they may be based on some combination of hardware and software. When hardware based, each of these components may be coupled together via one or more system buses.

The CAN interface 252 can be any circuitry and/or software that interacts with the CAN 119. For instance, the CAN interface 252 can identify the vehicle 101 (e.g., read or stores a vehicle identification number (VIN)) and/or write commands (e.g., lock, unlock, horn, light, and flash) to the CAN 119.

The CAN transceiver 254 can be any circuitry and/or software that can perform read and write operations in connection with the CAN interface (the CAN 125 itself).

The CSF module 256 can be any circuitry and/or software that acts as a cybersecurity device that establishes a software firewall which monitors and controls the incoming data communications received by the antenna system 121 and outgoing data communications created by the FVSM 120. As such, the CSF 256 attempts to lock malicious data transmissions from being received by any other system within vehicle 101 (for example, vehicle system modules such as, but not limited to, the BCM 124). The CSF 256 may moreover have the capability to both read and write messages from the CAN 125 as well as be able to stop messages from being written to the CAN 125 when required. The CSF 256 may moreover write messages based on requests from remote entity 114. The CSF 256 may log all successful connections and connection attempts for the NAD 272 and SRWC module as a read-only message which is stored in system memory device 203 and such read-only messages may be requested by and sent to remote entity 114. The CSF 256 may also include an independent microprocessor with a CAN bus interface to provide the software firewall gateway so as to limit message writing activity of the CAN 125.

The USB 258 can be any circuitry and/or software that enables physical connection by USB wiring a protocols.

The CMS 260 can be any circuitry and/or software that can perform hashing, signing, and secure storage. The CMS 260 encrypts the messages written via the CSF 256 before being established across the CAN 125 as well as securely store these messages in the system memory 203. The encryptions generated by the CMS 260 may be tamperproof and include hashing or signing to accomplish such an effect. As follows, the CMS 260 adds a layer of security that goes beyond the software firewall generated by the CSF 256. For example, if one or more hackers successfully accesses communications across the CAN 119, the accessory module-generated information would be encrypted and likely unreadable.

The RIB module 262 can be any circuitry and/or software that includes an inline PCB relay with separate input/output (I/O) lines. The RIB module 262 can enable a receipt of a remote signal to the vehicle 101 to prevent the vehicle 101 from restarting once an ignition therein is turned off.

The RIB driver 264 can be any circuitry and/or software that includes device and/or hardware drivers, as a group of files, which enable the RIB module 262 to devices to communicate with the FVSM 120 components.

The key fob board 266 can be any circuitry and/or software that includes a circuit or daughter board for I/O signals respective to key fob commands (e.g., executes operations of a virtual key fob). For instance, the key fob board 266 can utilize radio frequencies to unlock the vehicle 101. Further, the key fob board 266 includes the technological benefit of not requiring additional hardware (i.e., an embedded key fob circuit board) in the vehicle 101 itself. In this regard, the key fob board 266 supports a broader range of current and future vehicle makes and models (e.g., new/in-production) while combining the CAN 125 write capabilities for legacy vehicle makes and models (old/in-market). In accordance with one or more embodiments, the FVSM 120 can include a depopulated universal key fob board, as the key fob board 266, when being installed in a known legacy vehicle type with supported vehicle bus architecture.

The GPS module 270 can be any circuitry and/or software that enables FVSM 120 to receive radio signals from a constellation of GPS satellites, also known as a Global Navigation Satellite System (GNSS). From these signals, the GPS module 270 can determine vehicle position. The position information can then be supplied to remote entity 114, or some other remote computer system, for purposes such as vehicle fleet management. As such, the GPS module 270 may communicate with the NAD 272 to send the position information to remote entity 114 over a data channel via the wireless carrier system 116. It may be understood that the NAD 272 and the GPS module 270 may be combined into a single module (i.e., a NAD which supports GPS functionality).

The NAD 272 can be any circuitry and/or software that enables the FVSM 120 to conduct long distance data communications with remote entity 114 by implementing data communications over the wireless carrier system 116. For example, remote entity 114 may send a remote vehicle disable command to vehicle 101 via the NAD 272. Alternatively, vehicle diagnostics information may be transmitted to remote entity 114 via the NAD 272. The NAD 272 may also enable the FVSM 120 to communicate with other wireless-enabled devices (e.g., mobile device 112) via the wireless carrier system 116. The NAD 272 preferably uses radio signals to establish data channels with the remote entity 114 (or the mobile device 112) and provides data via packet transmissions and such transmissions may be in an SMS format. According to one embodiment, the NAD 272 allows for cellular communications according to standards such as GSM, UMTS, LTE, or 5G. It should be understood that the NAD 272 can control the antenna system 121 to send and receive data communications.

The RTC 274 can be any circuitry and/or software that manages a computer clock to keep track of the current time.

The power management module 276 can be any circuitry and/or software for power supply and maintenance. The power management module 276 can include at least a ground for the FVSM 120.

In certain embodiments, the FVSM 120 may include an external interface module (EIM) to allow the FVSM 120 to communicate with one or more external vehicle systems (e.g., aftermarket systems). For example, the EIM enables the FVSM 120 to be connected to, and in communication with, an aftermarket vehicle entertainment system (e.g., a headrest display screen) to enable the FVSM 120 to display messages at various points during the vehicle's operation.

FIG. 3 depicts a process flow 300 of the FVSM 120 according to one or more embodiments. The process flow 300 is an example of how the FVSM 120 can be utilized in the P2P car sharing service business model for a broad range of vehicle makes and models (e.g., legacy/old/in-market and current/future/new/in-production). More particularly, the software 208, which is stored as instructions on the system memory 203 for execution on the FVSM 120 by the processor 201, is executable by the processor 201 to cause the FVSM 120 to perform the process flow 300. The process flow 300 can be initiated within the FVSM 120 by communications received from the mobile device 112. In this regard, for example, a door unlock command can be sent by the ride sharing application of the mobile device to the FVSM 120, which upon receipt by the FVSM 120 begins the process flow 300 at block 310.

At block 310, the FVSM 120 detects a vehicle bus (e.g., the CAN 125 of the vehicle 101). Detection of the CAN 125 includes an acquisition of information of the CAN 125 and the vehicle 101. The FVSM 120 can utilize one or more of the CAN interface adapter 252, the CAN transceiver 254, and the NAD 272, along with the processor 201, to implement the detection of the CAN 125. At decision block 320, the FVSM 120 determines whether the CAN 125 is encrypted. The FVSM 120 can utilize one or more of the CFS 256 and the CMS 260, along with the processor 201, to implement the encryption determination. If the CAN 125 is not encrypted, then the process flow 300 proceeds to block 330 (as indicated by the N arrow). If the CAN 125 is encrypted, then the process flow 300 proceeds to decision block 335 (as indicated by the Y arrow).

At block 330, the FVSM 120 provides direct communication between the mobile device 112 and the vehicle 101, so as to perform vehicle access actions (e.g., the door unlock command). Direct communication can be implemented by the FVSM 120 through one or more of the CAN interface adapter 252, and the CAN transceiver 254, the NAD 272, the key fob board 266, along with the processor 201. For instance, the key fob board 266 can send signals using radio frequencies to unlock the vehicle 101. Note that, in some cases, the process flow 300 may continue to block 340 (as shown by the dashed arrow) despite the lack of encryption on the CAN 125, due to the presence of a cyber gateway module on the vehicle 101.

At block 335, the FVSM 120 can utilize one or more of the CFS 256 and the CMS 260, along with the processor 201, to implement encryption/decryption communications with the vehicle 101 to perform vehicle access actions.

At decision block 340, the FVSM 120 determines whether there is a gateway module of the CAN 125 (e.g., the cyber gateway module on the vehicle 101 can prevent communications). If the CAN 125 includes the gateway module, then the process flow 300 proceeds to block 350 (as indicated by the Y arrow). At block 350, the FVSM 120 communicates through the gateway module to perform vehicle access actions. Communicating through/with the gateway module by the FVSM 120 can be implemented through one or more of the CAN interface adapter 252, the CAN transceiver 254, the NAD 272, and the key fob board 266, along with the processor 201. If the CAN 125 does not include the gateway module, the process flow 300 proceeds to block 360 (as indicated by the N arrow), where the FVSM 120 performs (e.g., using the key fob board 266) operations of a virtual key fob to allow vehicle access actions.

Embodiments herein may be a system, a method, and/or a computer program product at any possible technical detail level of integration. The computer program product may include a computer readable storage medium (or media) having computer readable program instructions thereon for causing a processor to carry out aspects.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects.

Aspects are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A flexible vehicle sharing module of a vehicle, the flexible vehicle sharing module comprising:
a controller area network interface adapter that identifies the vehicle
a cybersecurity software firewall module that establishes a software firewall that monitors and controls incoming data communications to the flexible vehicle sharing module;
a key fob board comprising a circuit board for managing input/output signals respective to key fob commands; and
a cryptographic module that performs hashing, signing, and secure storage of messages to the vehicle.

2. The flexible vehicle sharing module of claim 1, further comprising a remote ignition block module including an inline printed circuit board relay with separate input/output lines that prevent the vehicle from restarting once an ignition therein is turned off.

3. The flexible vehicle sharing module of claim 1, further comprising a global position system that determines vehicle position.

4. The flexible vehicle sharing module of claim 1, further comprising a network access device that conducts long distance data communications with remote entity.

5. The flexible vehicle sharing module of claim 1, further comprising a real-time clock that manages a computer clock to keep track of the current time.

6. The flexible vehicle sharing module of claim 1, further comprising a power management module including at least a ground and provides a power supply and maintenance to the flexible vehicle sharing module.

7. The flexible vehicle sharing module of claim 1, wherein the flexible vehicle sharing module determines whether a controller area network of the vehicle requires encrypted communications.

8. The flexible vehicle sharing module of claim 1, wherein the flexible vehicle sharing module determines whether a gateway module is present within the vehicle.

9. The flexible vehicle sharing module of claim 1, wherein the flexible vehicle sharing module provides operations of a virtual key fob to allow vehicle access actions.

10. The flexible vehicle sharing module of claim 1, wherein the flexible vehicle sharing module receives communications from a mobile device.

11. A system comprising:
a mobile device comprising a memory and a processor, the memory storing program instructions executable by the processor; and
a flexible vehicle sharing module of a vehicle, the flexible vehicle sharing module comprising:
a controller area network interface adapter that identifies the vehicle;
a cybersecurity software firewall module that establishes a software firewall that monitors and controls incoming data communications to the flexible vehicle sharing module;
a key fob board comprising a circuit board for managing input/output signals respective to key fob commands; and
a cryptographic module that performs hashing, signing, and secure storage of messages to the vehicle.

12. The system of claim 11, wherein the flexible vehicle sharing module comprises a remote ignition block module including an inline printed circuit board relay with separate input/output lines that prevent the vehicle from restarting once an ignition therein is turned off.

13. The system of claim 11, wherein the flexible vehicle sharing module comprises a global position system that determines vehicle position.

14. The system of claim 11, wherein the flexible vehicle sharing module comprises a network access device that conducts long distance data communications with remote entity.

15. The system of claim 11, wherein the flexible vehicle sharing module comprises a real-time clock that manages a computer clock to keep track of the current time.

16. The system of claim 11, wherein the flexible vehicle sharing module comprises a power management module including at least a ground and provides a power supply and maintenance to the flexible vehicle sharing module.

17. The system of claim 11, wherein the flexible vehicle sharing module determines whether a controller area network of the vehicle requires encrypted communications.

18. The system of claim 11, wherein the flexible vehicle sharing module determines whether a gateway module is present within the vehicle.

19. The system of claim 11, wherein the flexible vehicle sharing module provides operations of a virtual key fob to allow vehicle access actions.

20. The system of claim 11, wherein the flexible vehicle sharing module receives communications from a mobile device.
